(19) United States
(12) Patent Application Publication
(10) Pub. No.: US 2006/0045956 A1
(43) Pub. Date: Mar. 2, 2006

(54) Process for preparing coated potato pieces using pregelatinized starch

(75) Inventors: Alan Thorpe, Summerside (CA); Wallace H. Kunerth, Parker, CO (US)

Correspondence Address: MARSHALL, GERSTEIN & BORUN LLP, 233 S. WACKER DRIVE, SUITE 6300, SEARS TOWER, CHICAGO, IL, 60606, US

(73) Assignees: PENFORD FOOD INGREDIENTS CO., Cedar Rapids, IA (US); CAVENDISH FARMS CORPORATION, Dieppe (CA)

(21) Appl. No.: 11/032,390

(22) Filed: Jan. 10, 2005

Related U.S. Application Data
(63) Continuation-in-part of application No. 10/926,876, filed on Aug. 26, 2004.

(51) Int. Cl. A23L 1/216

(52) U.S. Cl. 426/637

(57) ABSTRACT

The invention provides methods for coating potato strips using low levels of pre-gelled modified starches characterized by a Brookfield viscosity of from 15 to 100 cp when measured on a 6% solids basis. The invention also provides methods for coating potato strips using low levels of high amylose starches.

### RELATED APPLICATIONS

This is a continuation-in-part of U.S. application Ser. No. 10/296,876 filed Aug. 26, 2004, the disclosure of which is hereby incorporated by reference.

### BACKGROUND OF THE INVENTION

The present invention is directed to improved methods for the preparation of french fry products. One of the primary sensory attributes sought for french fry products is the ability to retain crispness when held under heat lamps. There is also a desire to reduce fat uptake during the frying steps. While crispness and fat content are major factors for consumers there exists a desire among restaurateurs to reduce the time to cook (finish fry) the frozen prepared french fry product. The art has developed a variety of methods and formulations to improve the quality of french fries many of which relate to the use of starch enrobing slurries (batters) which are applied at relatively high (4-12%) solids pickup levels to the potato strip to form a thin coating.

Methods for applying coatings to potato pieces are well known in the art. U.S. Pat. Nos. 6,033,697 and 5,885,639, describe dual coated french fry systems in which blanched potato slices are coated with a hydrocolloid layer on the surface of the strip, preferentially drying the strip and contacting the strip with a starch based slurry to provide a starch based batter coating over the hydrocolloid layer. Suitable hydrocolloids are identified as food gums, gelatin, pectins, high amylose starches, dextrins, maltodextrins, and the like. Hydrolyzed starches such as dextrins and maltodextrins having a dextrose equivalent value of less than about 12 are preferred for use as the hydrocolloid in coating the potato strips. The hydrocolloid solution is typically maintained at a temperature of about 130° F. to 180° F. The purpose of the hydrocolloid solution is to promote crispness of the potato strips and to promote adhesion of the subsequently applied batter. Following application of the hydrocolloid solution, the strips are dried and coated with an aqueous starch slurry by contacting the strips with an aqueous starch based batter containing one or more starches and flours typically used in the batter coating of potato strips. The slurry may also contain minor amounts of other ingredients.

U.S. Reissue Pat. No. Re-27,531 discloses a process of preparing french fries that includes dipping washed and optionally blanched potato pieces in a coating prior to deep frying. The coating is prepared by making an aqueous amylose suspension of 1-15% amylose by weight then heating the suspension to gelatinize the amylose, thereby to produce a colloidal dispersion. This patent further notes that high amylose corn starches with amylose contents of 55% minimum are used in this patent.

U.S. Pat. No. 3,175,914 discloses cooking potato pieces to gelatinize the natural starch, then washing to remove sugars from the surface, wetting the surface with aqueous gelatinized starch, then frying or parfrying the pieces. This patent utilizes a process whereby a native starch, without modification or cross linking, is gelatinized and applied to the strips immediately prior to parfrying. The patent notes that the starch is used at a concentration of 0.3 to about 10% and that the temperature of the dip solution must not be substantially lower than about 50° F., and may be elevated up to about 212° F. Solutions of pregelatinized native starches have high viscosities, and are very sticky, making drying of the strips to immobilize the starch film on the surface of the strip impractical.

U.S. Pat. No. 3,527,646 discloses a method of coating foods with an edible amorphous film containing a pregelatinized starch as the essential ingredient. This patent describes wetting the strip and then dry dusting the strips with a dry powder containing the pregelatinized starch. The coating is designed to provide a protective film on the food piece which gives a non-tacky surface and allows packing and handling of normally sticky foods. The patent notes that optimum results are achieved when powders are used containing different starches.

Similarly, U.S. Pat. No. 3,723,137 describes a process for forming a continuous adherent batter on a food piece. The patent states that “[a]lthough the amounts of gelatinized starch which is required to achieve the objects of the invention will vary depending upon the nature and amount of other ingredients in the composition, the utilization of at least 3 to 5 percent of gelatinized starch is critical to the formation of a continuous matrix or film embodying the coating. The patent identifies that a wide variety of materials may be employed such as modified or pre-gelatinized starches derived from corn starch, rice starch, potato starch, and preferably wheat starch, all of which may be used alone or in combination with each other. The patent also describes a process whereby the foodstuff is dipped in a fluid followed by dipping the food piece in a dry coating mix composition which includes the gelatinized starch source. The coated piece is then dipped again in a fluid. The patent notes that a significant amount of fluid in the range of 50 to 150 percent by weight of the dry coating composition is absorbed by the gelatinized starch thereby causing the formation of a uniform adherent coating utilizing relatively small amounts of coating composition.

U.S. Pat. No. 3,751,268 discloses a process of preparing french fried potatoes by coating potato pieces to be deep fried with an ungelatinized unmodified high amylose starch at a concentration of 0.1 to 1.5%, said starch having an amylose content of at least 50%. The patent notes that a further method that has been tried to coat the potato pieces before initial frying with a gelatinized starch solution of either a modified or unmodified starch but that this practice has never proven too effective, because the finished product lacks uniformity. The patent further notes that “[i]n addition, this method introduces additional cumbersome process steps since gelatinized starch solutions are difficult to handle.” The method of applying the starch to the potato piece is noted as being a dip in a solution of the starch which is maintained at a broad temperature range of 120° F. to about 180° F. because high amylose starches usually gelatinize at temperatures from about 190° F. to 198° F. The temperature of the dip solution used in this patent has been chosen as to prevent the gelatinization of the starch used to coat the food piece.

U.S. Pat. No. 4,317,842 discloses a process of preparing frozen par-fried potato strips capable of reconstruction in an oven by washing and peeling potatoes, then trimming, sorting, cutting, and blanching, then coating the pieces, oil soaking the pieces, and then par frying and freezing the pieces. The patent describes several different variations in the pre-treatment of the potato strips, including various methods of blanching the potato strips. One variation describes drying of the strips prior to application of the starch film. Once the pretreatment has concluded, the strips are coated. The coatings described for use according to this patent are an aqueous suspension of a film-forming hydrocolloid, glucose polymer, most preferably potato starch, which is not pregelatinized, but also makes note that pregelatinized starches may be used, although at a lower concentration. The potato starch solution used in the non-gelatinized version is a starch which contains more amylopectin than amylose, applied at a concentration of 1 to 10%, most preferable at a concentration of 5%. Once the pieces have been treated with the starch solution, they are dipped into an oil soak for 30 seconds to six minutes at a temperature of 49° C. to 121° C. which is said to be essential. Next the potato piece is par fried at 163° C. to 204° C. for 15 to 270 seconds and the product is then cooled to below 79° C. The high degree of heat treatment from the oil soak and the par fry result in a product with an extremely high oil content (15%) which is undesirable in a french Fry. In contrast, commercially prepared french fries have an oil content of only 4 to 6% oil.

U.S. Pat. No. 4,970,084 describes a process for making potato based chip products containing intact non-potato pieces. According to the process, non potato pieces are coated with a pregelatinized starch. to form a barrier which prevents bleeding of color out of the non potato pieces.

U.S. Pat. No. 6,274,184 B1 discloses a process for making potato particles, blanching, surface drying, and then coating them with pregelatinized and native starches. The coated particles are formed into the desired shape, and dried. The patent teaches that the purpose of the starch is to bind the large pieces of potato material together so that they will maintain the desired shape.

U.S. patent application Publication No. 2002/0172754 discloses a process for preparing potato pieces with a film like coating comprising cutting and blanching the potatoes, then coating them with a dry coating composition comprising at least 50% dextrin and from 5 to 25% hydrolyzed starch which has optionally been pregelled prior to acid hydrolysis.

European Patent EP 0 901 756 A2 discloses a method of applying a dusting of a non pregelled starch based product at greater than 60% solids to the surface of the potato strip.

U.S. patent application Publication No. 2002/0001663 discloses a process for making fries for oven baking wherein par-fried potato pieces are coated with a starch batter suspension including a low water solubility starch. The coating may be any of a broad range of starches including “Heat Treated starch”. The product produced by the process is required to have a very high solids content in the range of 48-62% solids.

U.S. patent application Publication No. 2001/0055637 describes preparation of oven baked french fries having an extended hold time. This process involves the coating of the strips with a starch suspension having a low water solubility starch as one of its components, and which contains 15 to 50% solids, wherein at least 40% of the solids of the coating consists of a low water solubility starch fraction having a water solubility index of less than 30%.

U.S. Pat. No. 6,080,434 describes an aqueous enrobing slurry for coating the outside surface of a bleached and dried potato product, having an as is solids content of at least 30% of a first cross linked starch, at least 2% by weight of a crosslinked dent corn starch having a cross linking level of at least 500 ppm and from 5 to 20% by weight dextrin and wherein the crosslinked dent corn starch is preferably acetylated. These coatings are described as being prepared at solids levels of 40%, giving a pickup of 20% based upon original (as is) strip weight.

U.S. Pat. No. 5,897,898 describes a starch slurry formulation comprising an ungelatinized starch hydrolyzate product with a DE between 0.2 and 0.8 for coating potato products. The patent describes a process whereby the batter is prepared by adding from 100% to 400% water resulting in a 50% to 20% solids content of the hydrated batter, and pickup of the batter is from about 8% to about 30%. This patent discloses that minor amounts of unmodified pregelled starches may be added to the slurry for viscosity control.

U.S. Pat. Nos. 5,302,410 and 5,393,552 disclose methods of coating potato strips with an aqueous immersion comprising salt, SAPP and potato maltodextrin with a DE of 6.

Of interest to the present invention and the disclosures of U.S. Pat. Nos. 4,542,030, 5,484,617, and 6,113,957 which describe processes for use of colorings in flume waters for the purpose of imparting a color to the finished product. These processes address the color of the fries but do not affect the textural properties of the french fried product.

### SUMMARY OF THE INVENTION

The present invention provides improvements in french fry coating methods. Specifically, the methods of the invention provide french fry products which exhibit good crispness and appearance properties. In particular, the appearance and color of the coated fries are unlike those of typical batter coated fries and appear more similar to uncoated french fries but have improved reconstitution and hold time when compared to conventional uncoated french fries.

According to one aspect of the invention, reconstitution (finish frying) time used to prepare the final french fry product may be substantially shortened while maintaining crispness and appearance properties similar to those of conventional uncoated french fry products. Thus, while medium thickness french fries served at fast food restaurants are typically finish fried at 350° F. for 3 minutes, french fries of the same dimensions coated according to the invention may be finish fried at 350° F. for 2.5 minutes while producing properties similar to those of the longer fried french fry product. The ability to reduce the time required for finish frying is particularly advantageous to fast food restaurants (also known as quick service restaurants, QSR) which tend to have peaks and valleys in demand. Thus, the ability to prepare french fries more quickly at a lunchtime rush hour can provide a significant commercial advantage to a fast food restaurant employing the products of the invention.

Alternatively, when it is not desired to reduce the finish frying reconstitution time, the coated french fries of the invention may be finish fried for the same amount of time as a conventional uncoated fry of the same dimensions in which case the resulting product has organoleptic and hold time properties superior to those of conventional french fry products finish fried for the same amount of time.

The present invention relates to the discovery that improved french fry products may be prepared by application of a light coating of a suspension of a selected pre-gelled modified starch after blanching and before parfrying of the potato strip. Significantly, this light coating has a substantially lower solids “pickup” on the resulting coated fry than typical batter coated fries. While conventional batter coated fries typically have a coating pickup of from 4% to 12% solids, the french fry products of the invention are characterized by lower coating pickups of from 0.3% to 3%. The modified starch suspension is applied such as by a dip, by spraying or in a flume and is applied with a viscosity and at a degree of solids such that the dry solids pick up on the coated potato strip ranges from 0.3% to 3% and more preferably from 0.5% to 2% and most preferably 0.5% to 1.5%. Such a dry coating weight is substantially less than that typically applied as a batter where the batter pickup is typically between 4% and 12% on a dry solids basis. Moreover, the french fry coating films of the present invention differ from batter coated films in that they tend to be imperceptible to the consumer. In contrast, french fries coated with batters at solids pick up levels of from 4% to 8% and higher have a readily perceptible coating. In addition, the present invention preferably comprises a single starch ingredient wherein conventional coatings generally comprise multiple starch and flour ingredients.

Specifically, the invention provides a method for producing a frozen potato product which comprises the steps of: cutting the raw potatoes; blanching the potatoes; optionally drying the potatoes, coating the potatoes with an aqueous suspension of a pre-gelled modified starch which modified starch is a cross-linked starch characterized by a Brookfield viscosity of from 15 to 100 cp when measured on a 6% solids basis; wherein the pre-gelled modified starch is applied in an aqueous suspension such that the solids pick up on the potato ranges from 0.3% to 3%; parfrying the coated potatoes in hot oil; and freezing the potatoes.

For purposes of determining the suitability of a particular modified pre-gelled starch for use according to the invention, a Brookfield viscosity may be determined for the starch at a 6% solids basis using a Brookfield Model LVT viscometer with a No. 1 spindle at 60 rpm at 75° F. for 40 seconds. (Water has a viscosity of 0 according to this method.) It should be understood that the modified starch may be applied at a different solids level and temperature and that the viscosity of the aqueous suspension applied to the potato strip may have a significantly different viscosity from the starch tested under these particular controlled conditions. Without intending to be bound by any particular theory of invention it is believed that the Brookfield viscosity measurement of the pre-gelled modified starch under these conditions relates to both the degree of gelatinization and coating ability of the starch and as such is an indication of the suitability of that starch for use in coating methods according to the invention. While starches having a Brookfield viscosity of from 15 to 100 cp under these conditions are believed to be capable of functioning according to the invention those pre -gelled modified starches characterized by a Brookfield viscosity of from 18 to 80 cp are more preferred with those characterized by viscosities of 20 to 40 cp are particularly preferred.

Modified starches according to the invention may be crosslinked with a variety of reagents known to those of skill in the art including POCl₃, sodium trimetaphosphate (STMP) or adipic anhydride (adipic acid). (Crosslinking levels as used herein refer to crosslinking with the stated concentration of POCl₃ in ppm, or the equivalent crosslinking level using a different crosslinking agent.) Preferred modified starches are those characterized by a crosslinking level of greater than 350 ppm based on POCl₃ crosslinking with those characterized by a crosslinking level of from 350 to 650 ppm being particularly preferred. Suitable modified starches include those selected from the group consisting of potato, tapioca, and corn starches including waxy maize, high amylose and dent corn starches, wheat, barley and yucca starches with crosslinked potato starch being particularly preferred. Waxy maize starch can be suitable when processed at high temperatures.

According to a further aspect of the invention, high amylose starches including unmodified cookup (non-pregelled) high amylose rice starches having amylose contents of greater than 20% and most preferably having an amylose content between about 25% and 33%; and high amylose maize starches having amylose contents of greater than 40% and preferably greater than about 50%, 60%, 70% and 80% amylose are useful in practice of the invention when applied in an aqueous suspension such that the solids pick up on the potato ranges from 0.5% to 3% with pickup ranges of from 0.5% to 3% and particularly around 2% being particularly preferred. According to a further aspect of the invention the high amylose starch is applied in an aqueous suspension characterized by a degree of solids of from 1% to 5%. While a preferred method of the invention involves application of the high amylose starch to the potato strip in a flume the starch may also be applied by immersion of the potato strip in a dip characterized by a viscosity of greater than 1000 cp.

It is contemplated that other non-crosslinked high amylose starches may be used in the methods of the invention. While the invention is primarily dedicated to the use of single starches it is contemplated that combinations of starches characterized by the parameters set out herein may also be used in the practice of the methods of the invention.

According to preferred methods of the invention the pre-gelled modified starch is applied in an aqueous suspension characterized by a viscosity of less than 1000 cp with application viscosities between 50 and 800 cp being particularly suitable when applied in a flume. (Viscosities of the aqueous suspensions are measured by a Brookfield DVII viscometer with a No. 4 spindle at 20 rpm at room temperature.) Higher viscosity suspensions having viscosities greater than 1000 cp may be used when applied as a spray or as a dip into which the potato strips are immersed.

The method of the invention is carried out wherein the pre-gelled modified starch is applied in an aqueous suspension characterized by degree of solids of from 1% to 20% with solids levels of 3% to 12% being preferred.

However applied, it is desired that the resulting coated potato product have a relatively light coating to provide the desired functional characteristics while minimizing the impression that the french fry is “coated.” Thus, the invention is typically practiced such that the resulting potato strip is characterized by solids pickup levels of from 0.3% to 3% with solids coating levels of from 0.5% to 2% being preferred and solids coating levels of from 0.5% to 1.5% being particularly preferred.

While the most preferred methods of the invention utilize a flume to apply the modified starches at low solids coating levels, the modified starches may also be applied by means of dips and sprays that optionally can (initially) apply a higher coating level of the modified starch to the potato strip than desired for the final product. Accordingly, steps may then be carried out to actively remove the pre-gelled modified starch from the coated strip prior to the parfrying step. Such steps can include the use of an airsweep or similar blowers or other means to remove pregelled modified starch from the potato strip to achieve a low coating level consistent with providing the desired properties of the invention.

According to one aspect of the invention, the modified starches may be applied in a flume which may already exist in the french fry preparation apparatus of a given manufacturer. Such flumes are currently used to apply various treatments to the potato strips including the application of a suspension of salt and SAPP. According to one aspect of the invention the modified starches of the invention may be efficiently applied to the potato strip in the same flume and suspension as the salt and SAPP.

The pre-gelled modified starch is preferably applied in an aqueous suspension characterized by a viscosity of less than 1000 cp at room temperature as measured by a Brookfield DVII viscometer with a No. 4 spindle at 20 rpm. When applied using a flume as is common in many french fry production systems the pre-gelled modified starch is applied in an aqueous suspension characterized by a viscosity of from 50 to 800 cp.

The pre-gelled modified starch is applied in an aqueous suspension characterized by degree of solids of from 1 to 20% with solids of from 3 to 12% being preferred and with a degree of solids of 5 to 10% being particularly preferred.

Nevertheless, the preferred method for practicing the invention comprises the application of the pregelled modified starch in a flume because of the process efficiencies involved. Specifically, in systems in which solutions of salt and sodium acid pyrophosphate (SAPP) are applied to cut potato strips in a flume the aqueous starch containing suspensions of the invention may be simultaneously applied.

Alternatively the pregelled modified starch maybe applied by immersion of the potato strip in a dip characterized by a viscosity of greater that 1000 cp.

According to another aspect of the invention the potato strips may optionally be partially dried before the coating step.

The starches are crosslinked such that they are characterized by a crosslinking level greater than 400 ppm (based on POCl₃ crosslinking or its equivalent with sodium trimetaphosphate (STMP) or adipic anhydride (adipic acid)) such that they are characterized by a viscosity of less than 100 cp when measured on a 6% solids basis as described above. More preferably the starches are characterized by a crosslinking level between 600 ppm and 1000 ppm with crosslinking levels between 350 ppm and 650 ppm being particularly preferred.

The modified starches useful according to the methods of the present invention are those which are pregelled. By “pregelled starch” it is intended that the starch be at least partially (but need not be completely) gelatinized with sufficient disruption of the starch granules among the modified starch granules such that there is some loss of birefringence when a suspension of starch particles is observed by polarized microscopy.

Modified starches which are useful in practice of the invention are those which have been modified in a fashion such that they have a viscosity of from 15 to 100 cp when measured at a 6% solids basis using a Brookfield Model LVT viscometer with a No. 1 spindle at 60 rpm at 75° F. for 40 seconds. Unmodified native starches are too thick to operate according to the invention while starches having medium or high levels of crosslinking sufficient to reduce viscosity levels less than 100 cp on a 6% solids basis are useful according to the invention. While starches modified by hydrolysis and/or oxidation can also exhibit viscosities less than 100 cp it has been found that starches in which the viscosity has primarily been reduced by oxidation or hydrolysis do not function according to the invention. In particular, such starches tend to form rough and or blistered films despite having a lowered viscosity.

While additional hydrocolloid ingredients such as other starches, flours, gums and the like may be incorporated into the aqueous suspension the invention's advantage lies in that a single pre-gelled modified starch may be used to coat the potato strips without resort to complicated and expensive blends of ingredients. In addition, the modified starches may be added in the same steps in which salt and SAPP are added to the potato strip.

Without intending to be bound by any particular theory of invention it is believed that cross-linked starches form discontinuous films on the surface of potato strips which allow steam and moisture to readily escape from the interior of the finish fried potato strip. In contrast, highly oxidized starches and highly hydrolyzed starches which have not been sufficiently crosslinked have film forming properties such that they tend to form continuous films on the surface of a potato strip. Such continuous films are disrupted, however, by steam and vapor escaping from the interior of the potato strip during finish frying with the result that the surface becomes rough and/or blistered and has an unacceptable appearance and texture. Accordingly, while modified starches useful according to the invention may have minor degrees of hydrolysis or oxidation they should be no more hydrolyzed than to be characterized by a DE of <0.3 and should be characterized by an oxidation level of less than 0.8% Cl if oxidized.

### DETAILED DESCRIPTION

The present invention provides frozen french fry products and methods for their preparation which provide improved sensory qualities while simultaneously providing reduced final cook times without reducing crispness. While prior art methods for the reduction of cook times have generally employed extra drying or additional frying to increase the solids of the potato strip, the methods of the present invention do not require such methods. Thus, unlike previous coating inventions which have required installation of specialized equipment such as dusters, batter applicators or additional dips in order to take advantage of the invention, the current invention can be used on a regular french fry manufacturing line with little or no modification. In particular, the invention can use existing dip, spray and flume operations that are already used to apply other ingredients such as salt and sodium acid pyrophosphate (SAPP) solutions, color and flavoring solutions conventionally applied in the process of manufacturing frozen potato strips.

The present invention provides parfried potato strips which can be reconstituted in up to 25% less time and still have superior crispness without becoming chewy upon extended holding under heat lamps which is common in fast food restaurants. In addition, the invention provides products which are indistinguishable from conventional untreated french fried potato strips.

The product produced using this invention has a lower finished fat content, with reduced energy requirements to cook the product in a restaurant. Even modest reductions in fry oil content can represent significant overall monetary savings. Indeed the invention largely overcomes the processing difficulties which are frequently encountered with battered fries. Due to the extremely thin coating applied to the product, the invention also reduces the amount of crumbs which accumulate in the fryers when the product is cooked at the restaurant. These crumbs are a major factor in increasing the oil cost to the restaurant through breakdown of the oil.

All french fry operations employ the use of a chelating agent at a concentration of 0.2-1.2% by weight in the solution, generally Sodium Acid PyroPhosphate (SAPP), to complex the iron in the potato and prevent the after cooking darkening reaction. The solution may also contain dextrose, coloring, flavoring, salt or other ingredients incidental to the production of the product, but which have no crispness enhancing effect. This solution is applied in a number of different ways. Some processing facilities use a flume system to carry the blanched potato pieces from the blancher exit to the next step in the process. This is generally a contained water system which may be open or closed. The system once it has transported the product is separated from the product by use of a vibrating dewatering shaker. The SAPP solution may also be applied in a dip solution where the product is transported through a dip solution on a conveyor which has perforations or is made of a wire mesh or rod material to allow free application and draining of the solution. The solution may also be sprayed onto the fries through the use of spray nozzles located above the product. The current invention is applicable to all of these various methods of application.

In accordance with the invention, raw potatoes are washed, optionally peeled, optionally preheated to facilitate cutting, cut into strips of the desired size, blanched, and coated with a suspension of pregelatinized, starch such that the solids content of the starch is from 1-10% and optimally 5-9% in the solution. Once coated, the strips may be optionally passed under high velocity air to remove excess starch solution. Strips treated in this manner will pick up 10-22% of the precoated weight of solution, equivalent to a pickup of 0.5 to 1% dry weight starch. The strips may then be air dried using a conventional french fry dryer at typical times and temperatures. The object of the drying step is to reduce the moisture content of the coating to a level where the strips no longer adhere to each other. After drying, the french fry strips are par-fried in a conventional manner using standard times and temperatures.

According to one aspect of the invention, it is possible to add the starch solution to either flumes or dip tanks or spray applications due to the low viscosity of the starch solution. Starches which are not pregelatinized require much longer fry times to cook the starch in the fryer, lowering production volumes through the process, and are not applicable to the invention, as they leave a powdery residue on the surface of the strips after drying, and give no appreciable increase in the crispness of the strips. They also tend to make the strips stick together in the frying process, producing undesirable clusters. Surprisingly, unlike prior art processes, the methods the invention do not require an additional added ingredient in order to enhance crispness and reduce reconstitution times. Unlike other treatments no other added ingredients are necessary to achieve the enhanced crispness and decreased reconstitution times. The following examples are intended to illustrate, but not to limit the present invention. Unless otherwise indicated, all percentages are by weight.

Products produced using this process were evaluated against regular non-coated french fries in order to determine the amount of reconstitution fry time reduction that could be achieved using this process, and to rate the coated fries with reduced reconstitution against regular fries which were reconstituted at regular reconstitution times and temperatures. In all instances, the fries were reconstituted by frying a two pound sample in an institutional fryer at a temperature of 350° F.

In general, thick coatings applied to french fry strips act to increase the cook time and to increase the oil content of the finished product. Restaurant operators require a product which can be fried in the quickest time possible. Thawing of most battered products prior to frying is not advisable since the battered pieces either tend to stick together, or the coating falls off of the product. Using the present invention, a product can be produced which not only reduces the fry time of the product, but reduces the oil content of the product as well, resulting in a healthier fry. Alternately, the food service operator can use the product produced with this invention cooked at the full fry time to yield a product with increased crispness and holding time

### EXAMPLE 1

French fries cut at a raw cut size of ⅜× 5/16 inch raw cut size which had been washed, conditioned, cut, blanched and dipped in a solution containing 1% Sodium Acid pyrophosphate and 0.80% dextrose on a regular french fry line were dipped into a 9% solution of a pregelatinized and cross linked (930 ppm) potato starch having a viscosity of 200-300 centipoise ( Brookfield DVII+ Spindle 4, 20 rpm) at a temperature of 72° F. (available commercially as Penplus 108 (Penford Food Ingredients, Englewood, Colo.)). This pregelled starch is characterized by a Brookfield viscosity of 18 cp when measured at 6% solids using a Brookfield LVT viscometer with a No. 1 spindle at 60 rpm at 75° F. for 40 seconds. The strips were passed under a blower to remove excess starch solution leaving a wet pickup ((Post dip weight−pre dip weight)/pre dip weight)) of 12%. This is equivalent to the addition of 1.08% of the cross linked starch on a dry weight basis to the surface of the strip. The strips were then placed into a wire mesh basket and replaced onto the bed of the french fry dryer, and were allowed to proceed through the remainder of the french fry process with the untreated strips. This included the steps of drying, frying, and freezing the french fries. This process allowed a direct comparison of the effects of the addition of the starch solution to the outside surfaces of the fry strips without introducing any additional variables.

Once the dipped fries were frozen, they were removed from the fry line, and a sample of non treated fries was taken from the fry line in order to provide a reference sample for the degree of crispness of the strips. A one pound sample of starch dipped fries was placed into one fry basket and a one pound sample of regular fries from the reference sample was placed into a second fry basket. Both samples were fried at the same time in a 40 pound Hobart fryer set at 350° F. The dipped fries were fried for 2 minutes and 30 seconds, and were then immediately transferred to a fry holding station utilizing four 275 watt infrared heating bulbs located 18 inches from the grate surface. The regular fries were fried for an additional 30 seconds and were then placed into the fry holding station immediately beside the coated fries. Both samples were held under the heat lamp for a period of seven minutes and were then removed for sensory analysis. The degree of crispness and toughness were evaluated immediately after removing the samples from the holding station. As the purpose of this invention is to provide a method to reduce the reconstitution of the strips and still retain all the crispness of the fry, the crispness of the regular fry when reconstituted normally was used as the reference level for crispness. The crispness was rated on a scale of 1-10 with 10 being the best, where a crispness of 6 was arbitrarily assigned to the crispness level of the regular fries reconstituted under recommended conditions, and held under heat lamps in an institutional fry holding station.

TABLE 1

| | | % Oil in |
|---|---|---|
| Treatment | Degree of Crispness | Reconstituted Product |
| Pregel Starch | 8.5 | 12.2% |
| Regular Fries | 6 | 14.5% |

The texture of the fries coated with the pregelled cross linked starch was found to be identical to that of the regular fries, with a higher degree of crispness. Many of the treatments which have been recommended for increasing the crispness of fries not only increase the crispness of the fries, but change the type of crispness. Batter coatings tend to give coatings whose crispness can be described as brittle, short, or tough, depending upon the combination of ingredients used. The results in Table 1 show that potato product coated with this type of starch are comparable to regular french fries, even with a reduced fry time for reconstitution. Batters containing wheat flour tend to lose their crispness quickly as the batter rehydrates, whereas batters or coatings with high levels of starches tend to become tough and chewy.

### EXAMPLE 2

According to this example, the fries as prepared in example 1 were treated with solutions of varying concentrations of a pregelled cross linked starch (Penford Food Ingredients product Penplus -10®), and compared to the control to determine the amount of pregelatinized starch which was necessary to duplicate the sensory characteristics of regular fries with a 30 second reduction in the fry time of the dipped fries.

| | | % Oil in |
|---|---|---|
| Treatment | Degree of Crispness | Reconstituted Product |
| Pregel Starch 3% | 4 | 14.6 |
| Pregel Starch 5% | 6 | 13.0 |
| Pregel Starch 7% | 7 | 12.8 |
| Pregel Starch 9% | 9 | 12.4 |
| Pregel Starch 11% | 7 | 12.6 |
| Pregel Starch 15% | 3 | 14.3 |
| Regular Fries | 6 | 14.4 |

The fries which had been dipped into the 15% pregelled starch solution were found to become somewhat chewy after the hold time under the heat lamp, indicating that this level of starch exceeds the practical application limit. The result indicate that for a reduction in fry time of 30 seconds off of the conventional reconstitution time a solution with a pregelatinized cross linked content of 5% was necessary. This experiment also showed that the optimal concentration of starch in the dip solution was in the range of 9% to 15% in order to give optimal crispness. The range of concentration to give the best fry, using this level of sensory scoring was between 5 and 11%.

### EXAMPLE 3

According to this example, the maximum amount of reconstitution time/oil reduction that could be achieved when using a 9% solution of the pregelled cross linked starch of Example 1 was determined. The results in Table 3 show that using a 9% level of the starch that optimal texture was obtained with fry time reductions of 40 seconds or less. Longer reductions, while lowering the fat content of the strips resulted in strips which were significantly less crisp than the untreated control.

TABLE 3

| | | % Oil in |
|---|---|---|
| Fry Time Reduction | Degree of Crispness | Reconstituted Product |
| 30 Seconds | 6 | 12.2 |
| 40 Seconds | 6 | 11.8 |
| 50 Seconds | 5 | 10.3 |
| 60 Seconds | 4 | 10.5 |

Lower levels of starch (Lower than 9%) would be expected to give similar oil data, but lower degrees of crispness. Frying of regular (Untreated) fries will also show the same trend, namely a reduction of oil content as the fry time decreases.

### EXAMPLE 4

According to this example, the maximum amount fry time reduction which could be achieved by pre-thawing the strips before frying them was determined. In this example, pre-thawing is described as holding the french fries at a temperature of 40° F. for 24 hours, such that the temperature of the fries at the time of frying is equilibrated to the holding temperature of 40° F. All dipped fries were prepared using a 9% dip solution of the pregelled 930 ppm cross linked potato starch of Example 1.

TABLE 4

| | | |
|---|---|---|
| | | % Oil in |
| Fry Time Reduction | Degree of Crispness | Reconstituted Product |

Dipped Fries

| | | |
|---|---|---|
| 0 Seconds | 8 | 16.2 |
| 30 Seconds | 7 | 14.1 |
| 40 Seconds | 7 | 13.7 |
| 50 Seconds | 6 | 12.5 |
| 60 Seconds | 6 | 12.2 |

Regular Fries

| | | |
|---|---|---|
| 0 Seconds | 6 | 14.4 |
| 30 Seconds | 5 | 13.5 |
| 40 Seconds | 4 | 13.2 |
| 50 Seconds | 3 | 12.4 |
| 60 Seconds | 1 | 12.0 |

Table 4 shows that pre-thawing the coated fries before thawing results in significantly crispier fries. This observation is enhanced when fry time reductions are on the order of less or equal to 40 seconds.

### EXAMPLE 5

According to this example, the amount of increased hold time that could be achieved was determined by frying the product made with this invention for the full recommended fry time for regular fries. In this experiment, fries produced using a starch dip concentration of 9% as described in Experiment 1 were fried for the full 3 minute fry time at 350° F., and placed into the fry holding station. The fries were held for 5 minutes in the holding station (standard holding conditions for the QSR industry when using non-coated fries), and were evaluated every minute thereafter for crispness until such time as the crispness of the fries decreased below that for regular fries held under the heat lamp for 5 minutes with the results shown in Table 5 below.

TABLE 5

| Holding Time | Degree of Crispness |
|---|---|
| 6 Minutes | 6 |
| 7 Minutes | 6 |
| 8 Minutes | 5.5 |
| 9 Minutes | 5 |
| 10 Minutes | 4 |

### EXAMPLE 6

According to this example, tests were designed to evaluate modified and unmodified starches for suitability for practice according to the invention. The resulting french fries were evaluated for potential suitability based upon a 30 second reduction in standard finish frying time with the results shown in Table 6 below. A control sample (uncoated regular french fries of the same cut size) was run in parallel with the tests, which was treated identically, and this control sample was used in the sensory evaluation of the finished product resulting from each trial. The control was reconstituted by frying the product for 3 minutes at 350° F. All products were tested as described in Example 1.

TABLE 6

| | | | Evaluation |
|---|---|---|---|
| | | | Score |
| | | % | At 30 Seconds |
| Run | Starch | Moisture | Fry Reduction |
| 6-1 | Acid thinned Potato | 8% | Not Acceptable |
| 6-2 | 990 ppm POCl₃, 1.2-1.5% acetyl | 12% | Not Acceptable |
| | Potato | | |
| 6-3 | XL (650 ppm POCl₃) + Bleached | 12% | Not Acceptable |
| | (0.3% Cl) Potato | | |
| 6-4 | XL (650 ppm POCl₃) Tapioca | 12% | Promising |
| 6-5 | Gelose ® 50 (unmodified) HA Corn | 12% | Promising |
| | 50% Amylose | | |
| 6-6 | Gelose ® 80 (unmodified) HA Corn | 12% | Promising |
| | 80% Amylose | | |
| 6-7 | Oxidized Gelose ® 50 (4% Cl) HA | 12% | Promising |
| | Corn 50% Amylose | | |
| 6-8 | XL (900 ppm POCl₃) + Bleached | 10% | Promising |
| | (0.3% Cl) Waxy Maize | | |
| 6-9 | XL (900 ppm POCl₃) + Ac (1.5%) | 12% | Not Acceptable |
| | Waxy Maize | | |
| 6-10 | XL (600 ppm POCl₃) Waxy Maize | 10% | Promising |
| 6-11 | XL (900 ppm POCl₃) Waxy Rice | 10% | Not Acceptable |
| 6-12 | XL (400 ppm POCl₃) Potato | 10% | Not Promising |
| 6-13 | XL (550 ppm POCl₃) Potato | 12% | Not Acceptable |
| 6-14 | XL (675 ppm POCl₃) Potato | 10% | Promising |
| 6-15 | XL (800 ppm POCl₃) Potato | 12% | Not Acceptable |
| 6-16 | XL (990 ppm POCl₃) + 1.5% | 12% | Not Acceptable |
| | NaCl Potato | | |

### EXAMPLE 7

In this experiment, the starches from experiment 6 which showed promise were retested to confirm their applicability to the method of the invention.

TABLE 7

| | | | | Evaluation |
|---|---|---|---|---|
| | | | | Score at |
| | | | | 30 |
| | | Starch | Viscosity | Seconds |
| | | in | (cp) as | Fry |
| Run | Starch | Soln. % | applied | Reduction |
| 7-1 | XL (650 ppm POCl₃) Tapioca | 3.95% | 550 | Not |
| | | | | Acceptable |
| 7-2 | Gelose ® 50 (unmodified) | 7.91% | 260 | Not |
| | HA Corn 50% Amylose | | | Acceptable |
| 7-3 | Gelose ® 80 (unmodified) | 7.36% | 290 | Acceptable |
| | HA Corn 80% Amylose | | | |
| 7-4 | Oxidized Gelose ® 50 | 7.82% | 290 | Not |
| | (4% Cl) HA Corn 50% | | | Acceptable |
| | Amylose | | | |
| 7-5 | XL (900 ppm POCl₃) + | 6.19% | 340 | Acceptable |
| | Bleached (0.3% Cl) | | | |
| | Waxy Maize | | | |
| 7-6 | XL (600 ppm POCl₃) | 6.98% | 280 | Not |
| | Waxy Maize | | | Acceptable |
| 7-7 | XL (400 ppm POCl₃) Potato | 14.60% | 260 | Not |
| | | | | Acceptable |
| 7-8 | XL (675 ppm POCl₃) Potato | 8.33% | 190 | Acceptable |
| 7-9 | Gelose ® 80 (unmodified) | 7.41% | 120 | Not |
| | HA Corn 80% Amylose | | | Acceptable |
| 7-10 | Very highly crosslinked | 7.80% | 10 | Not |
| | potato starch | | | Acceptable |
| | (i.e., resistant starch). | | | |

*Brookfield (DV II+) Viscosity Centipoise (Spindle 4, 20 rpm) as applied to the potato strip

### EXAMPLE 8

According to this example, the starches evaluated in the Table 7 were mixed at a concentration as indicated in Table 7 separately in both cold (50° F.) and hot (150° F.) water to determine the time necessary for full development of viscosity, indicating full dissolution of the starch in the water solution as defined by the stabilization of viscosity and visual observation. For the purposes of this experiment, a 20 minute time frame was taken as a maximum time for holding of the starch. For starches which did not hydrate the solution was used at the 20 minute maximum for preparation of samples for sensory testing. Percentages of starches as listed in Example 7 were added to water with constant mixing of the starch solution using a Kitchen Aid Mixer with wire whip attachment set at a speed setting of 3. After each 5 minutes of mixing, the viscosity of the solution was measured using a Brookfield DV II rotary viscometer using Spindle 4 and a speed of 20 rpm. At the point in time where the viscosity stabilized, indicating full hydration of the starch, or at the end of the 20 minutes of mixing for those starches which were resistant to hydration, the solution was used to dip fries for sensory evaluation. Tables 8A and 8B below show the results of this test.

TABLE 8A
Mixed at 50° F.

| | | | Viscosity | | Viscosity | | | | |
|---|---|---|---|---|---|---|---|---|---|
| | | Starch | (cp) of | | (cp) of | | Dry | | |
| | | in | starch at | | suspension | | Pickup | | |
| | Starch | Soln. % | 6% solids | | as applied | | (%) | Sensory | |
| 8-1 | XL Ac Waxy | 3.95 | 6000 | cP | 680 | cP | 0.74 | 6 | Smooth |
| | Rice | | | | | | | | |
| 8-2 | Oxidized | 7.91 | 22.5 | cP | 40 | cP | 0.62 | 5* | Rough |
| | Gelose ® 50 | | | | | | | | |
| | HA Corn | | | | | | | | |
| | 50% Amylose | | | | | | | | |
| 8-3 | XL (600 ppm | 7.36 | 22.5 | cP | 190 | cP | 1.95 | 6 | Blistered |
| | POCl₃) Waxy | | | | | | | | |
| | Maize | | | | | | | | |
| 8-4 | XL (900 ppm) + | 7.82 | 16 | cP | 210 | cP | 1.36 | 6* | Rough |
| | Bleached | | | | | | | | |
| | (0.3% Cl) | | | | | | | | |
| | Waxy Maize | | | | | | | | |
| 8-5 | XL (400 ppm | 6.19 | 25 | cP | 100 | cP | 0.68 | 6.5 | Slight |
| | POCl₃) Potato | | | | | | | | Roughness |
| 8-6 | XL (550 ppm | 6.98 | 24 | cP | 20 | cP | 0.78 | 5 | Smooth |
| | POCl₃) Potato | | | | | | | | |
| 8-7 | XL (650 ppm | 14.60 | 12 | cP | 170 | cP | 2.19 | 5.5 | Smooth |
| | POCl₃) | | | | | | | | |
| | Tapioca | | | | | | | | |
| 8-8 | Gelose ® 50 | 8.33 | 26 | cP | 100 | cP | 1.31 | 7 | Rough |
| | (unmodified) | | | | | | | | |
| | HA Corn | | | | | | | | |
| | 50% Amylose | | | | | | | | |
| 8-9 | Gelose ® 80 | 7.41 | 16 | cP | 20 | cP | 0.66 | 5 | Rough |
| | (unmodified) | | | | | | | | |
| | HA Corn | | | | | | | | |
| | 80% Amylose | | | | | | | | |
| 8-10 | XL | 7.80 | 3 | cP | 60 | cP | 0.52 | 6* | Smooth |
| | (STMP/STPP, | | | | | | | | |
| | <0.4% | | | | | | | | |
| | Phosphorus) | | | | | | | | |
| | Potato | | | | | | | | |
| 8-11 | XL (930 ppm | 9.00 | 18 | cP | 150 | cP | | 6 | Smooth |
| | POCl₃) Potato | | | | | | | | |

*Sensory Rating at 30 Sec. Reduced Fry. Control (Untreated fries) at full fry time sensory rating = 6.

TABLE 8B
Mixed at 150° F.

| | | Starch | Viscosity | Viscosity (cp) | | |
|---|---|---|---|---|---|---|
| | | in | (cp)of starch | of suspension | | |
| | Starch | Soln. % | at 6% solids | as applied | Sensory | |
| 8-1 | XL Ac Waxy Rice | 3.95 | 6000 | 510 | 5 | Smooth |
| 8-2 | Oxidized Gelose ® | 7.91 | 22.5 | 50 | 5 | Smooth |
| | 50 HA Corn 50% | | | | | |
| | Amylose | | | | | |
| 8-3 | XL (600 ppm | 7.36 | 22.5 | 210 | 8* | Smooth |
| | POCl₃) Waxy | | | | | |
| | Maize | | | | | |
| 8-4 | XL (900 ppm) + Bleached | 7.82 | 16 | 200 | 6 | Slightly |
| | (0.3% | | | | | Rough |
| | Cl) Waxy Maize | | | | | |
| 8-5 | XL (400 ppm | 6.19 | 25 | 100 | 7 | Smooth |
| | POCl₃) Potato | | | | | |
| 8-6 | XL (550 ppm | 6.98 | 24 | 40 | 5 | Smooth |
| | POCl₃) Potato | | | | | |
| 8-7 | XL (650 ppm | 14.60 | 12 | 360 | 5 | Smooth |
| | POCl₃) Tapioca | | | | | |
| 8-8 | Gelose ® 50 | 8.33 | 26 | 100 | 7 | Rough |
| | (unmodified) HA | | | | | |
| | Corn 50% | | | | | |
| | Amylose | | | | | |
| 8-9 | Gelose ® 80 | 7.41 | 16 | 40 | 5 | Rough |
| | (unmodified) HA | | | | | |
| | Corn 80% | | | | | |
| | Amylose | | | | | |
| 8-10 | XL (STMP/STPP, | 7.80 | 3 | 30 | 6* | Smooth |
| | <0.4% | | | | | |
| | Phosphorus) | | | | | |
| | Potato | | | | | |
| 8-11 | XL (930 ppm | 9.00 | 18 | 160 | 7.5 | Smooth |
| | POCl₃) Potato | | | | | |

*Sensory Rating at 30 Sec. Reduced Fry. Control (untreated fries) at full fry time sensory rating = 6.

The results shown in Tables 8A and 8b show that pre-gelled modified starches which are characterized by a Brookfield viscosity of between about 15 cp and 30 cp when measured at 6% solids using a LVT Model viscometer at 60 rpm with a No. 1 spindle as is mixed for 40 seconds at 75° F. are particularly preferred.

### EXAMPLE 9

According to this example, non-pregelled high amylose starches were compared with pregelled starches evaluated according to the general method of Example 1. Specifically, a pregelled unmodified waxy starch and a pregelled crosslinked, acetylated rice starch (REMY) were compared against non-pregelled (cook-up) high amylose starches including a high amylose rice starch (REMY B7) characterized by an amylose content of between 25 and 33%; resistant starch derived from high amylose maize starch (Hi-Maize® 1043) characterized by an amylose content of 85% and a resistant starch content of 65%; 50% Amylose Maize Starch (Gelose® 50); and 80% Amylose Maize Starch (Gelose® 80).

Starch was dispersed in stainless steel bowls at the as-is solids levels indicated in Table 9. The starch products were dispersed for approximately 25 seconds at which time Brookfield viscosities were measured (#4 Viscometer @ 50 rpm at room temperature).

Shoestring fries were obtained from a production line after the dryer and maintained in water prior to testing. About 300 grams of potato strips were dipped and kept in the starch dispersion for approximately 3 to 5 seconds. The dipped potato products were then drained slightly followed by par-frying at 385° F. for 12-13 seconds in a pilot plant continuous fryer. The coated products were then immediately blast frozen at −40° C. overnight.

An additional set of examples were carried out wherein Runs 9-2, 9-12 and 9-16 were repeated as above. Before par frying however, the coated fries were passed through an impingement oven set at 120° F. for 2 minutes in order to “set” the coating.

Finish frying of the frozen products was carried out at 350° F. for 2 minutes for all examples. The control consisted of uncoated QSR (quick serve restaurant) fries, par fried as above and finish fried at 350° F. for 2 and one half minutes. All samples were maintained under heat lamps (160-170° F.) for 5 minutes before the sensory evaluation.

The results shown in Table 9 (which assign a sensory score of 5 to the conventional uncoated french fries as a control) indicate that non-pregelled high amylose rice starch (Run 9-4) and the high amylose (50%) maize starch (Run 9-12) provide particularly good results when applied at solids levels of about 3%. In addition, the modified pregelled rice starch (Run 9-22) and unmodified pregelled waxy rice starch (Run 9-2) showed promising results. Interestingly, when the pregelled unmodified waxy rice starch (Run 9-2) and the non-pregelled high amylose containing starches (Runs 9-4 and 9-5) were “heat set” functionality was improved. Of considerable interest is the observation that an in-process “set-time” may be useful in order to benefit final fry crispiness and appearance without interference with flavor.

TABLE 9

| | | | | Viscosity | | |
|---|---|---|---|---|---|---|
| | | Starch | % | (cp) as | Sensory | |
| Run | Starch | in Soln. % | Pickup | applied | Score | Evaluation |
| 9-1 | Pregelled Unmodified Waxy Rice | 1 | 0.7 | 78 | 5.3 | About equal to control |
| 9-2 | Pregelled Unmodified Waxy Rice | 3 | 5.3 | 140 | 5.5 | Slightly better than control |
| 9-3 | HA Rice 25-33% Amylose non-pregelled | 1 | 2 | 60 | 4.8 | Not as good as control |
| 9-4 | HA Rice 25-33% Amylose non-pregelled | 3 | 2.3 | 200 | 6.5 | Improved over control- |
| | | | | | | slightly tough |
| 9-5 | HA Rice 25-33% Amylose non-pregelled | 5 | 2.3 | 340 | 6 | Improved overall over control |
| 9-6 | HA Rice 25-33% Amylose non-pregelled | 7 | 2.6 | | 5.5 | Slight decrease in crispness |
| 9-7 | Resistant Starch (Hi-Maize ®) | 1 | 0.1 | 0 | 5.8 | Slightly better than control |
| 9-8 | Resistant Starch (Hi-Maize ®) | 3 | 1.7 | 0 | 5.2 | About equal to control and tough |
| 9-9 | Resistant Starch (Hi-Maize ®) | 5 | 1.6 | 0 | 5 | About equal to control-not as good |
| | | | | | | as 9-8 noticeably tough |
| 9-10 | Resistant Starch (Hi-Maize ®) | 7 | 2.4 | 20 | 4.8 | Poor mouth appeal |
| 9-11 | Gelose ® 50 (unmodified) HA Corn 50% Amylose | 1 | 2.9 | | 5.5 | Crispier than control |
| 9-12 | Gelose ® 50 (unmodified) HA Corn 50% Amylose | 3 | 2.6 | | 6.5 | Crispier than control-good texture |
| 9-13 | Gelose ® 50 (unmodified) HA Corn 50% Amylose | 5 | 1 | | 6.2 | Almost the same as 9-12 |
| 9-14 | Gelose ® 50 (unmodified) HA Corn 50% Amylose | 7 | 1 | | 4.5 | Not as good as control |
| 9-15 | Gelose ® 80 (unmodified) HA Corn 80% Amylose | 1 | 0.7 | 38 | 4.5 | Not as good as control-tougher |
| 9-16 | Gelose ® 80 (unmodified) HA Corn 80% Amylose | 3 | 1.6 | 40 | 4.8 | Not as good as control-tougher |
| | | | | | | and less crispy |
| 9-17 | Gelose ® 80 (unmodified) HA Corn 80% Amylose | 5 | 1.2 | 42 | 4.5 | Not improved over control |
| 9-18 | Gelose ® 80 (unmodified) HA Corn 80% Amylose | 7 | 1.3 | | | Not scored-same as above |
| 9-19 | Pregelled Crosslinked, Acetylated Rice (REMY) | 1 | 2 | 0 | 4.5 | Not as good as control |
| 9-20 | Pregelled Crosslinked, Acetylated Rice (REMY) | 3 | 10.7 | 12 | 4.5 | Same as 9-19 |
| 9-21 | Pregelled Crosslinked, Acetylated Rice (REMY) | 5 | 10.4 | 10.7 | 4.8 | Slightly better than 9-21 |
| 9-22 | Pregelled Crosslinked, Acetylated Rice (REMY) | 7 | | | 5.5 | Better than control-good flavor |

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed is:

1. A method for producing a frozen potato product which comprises the steps of:
cutting the raw potatoes;
blanching the potatoes;
coating the potatoes with an aqueous suspension of a pre-gelled modified starch which modified starch is a cross-linked starch characterized by a Brookfield viscosity of from 15 to 100 cp when measured on a 6% solids basis;
wherein the pre-gelled modified starch is applied in an aqueous suspension such that the solids pick up on the potato ranges from 0.3% to 3%;
parfrying the coated potatoes in hot oil; and
freezing the potatoes.

2. The method of claim 1 wherein the pre-gelled modified starch is characterized by a Brookfield viscosity of from 18 to 80 cp when measured on a 6% solids basis.

3. The method of claim 1 wherein the pre-gelled modified starch is characterized by a Brookfield viscosity of from 18 to 40 cp when measured on a 6% solids basis.

4. The method of claim 1 wherein the pre-gelled modified starch is characterized by a crosslinking level of greater than 350 ppm based on POCl3 crosslinking.

5. The method of claim 1 wherein the modified starch is characterized by a crosslinking level of from 350 to 1000 ppm.

6. The method of claim 1 wherein the modified starch is selected from the group consisting of potato, tapioca, corn starches, wheat, barley and yucca.

7. The method of claim 1 wherein the modified starch is a potato starch.

8. The method of claim 1 wherein the pre-gelled modified starch is applied in an aqueous suspension characterized by a viscosity of less than 1000 cp.

9. The method of claim 1 wherein the pre-gelled modified starch is applied in an aqueous suspension characterized by a viscosity of from 50 to 800 cp.

10. The method of claim 1 wherein the pre-gelled modified starch is applied in an aqueous suspension characterized by a degree of solids of from 1% to 20%.

11. The method of claim 1 wherein the pre-gelled modified starch is applied in an aqueous suspension characterized by a degree of solids of from 3% to 12%.

12. The method of claim 1 wherein the wherein the pre-gelled modified starch is applied in an aqueous suspension such that the solids pick up on the potato ranges from 0.5% to 2%.

13. The method of claim 1 wherein the wherein the pre-gelled modified starch is applied in an aqueous suspension such that the solids pick up on the potato ranges from 0.5% to 1.5%.

14. The method of claim 1 wherein a step is carried out to actively remove the pre-gelled modified starch from the potato strip prior to the parfrying step.

15. The method of claim 14 wherein an airsweep is used to remove pregelled modified starch from the potato strip prior to the parfrying step.

16. The method of claim 1 wherein the pregelled modified starch is not actively removed from the potato strip prior to the parfrying step.

17. The method of claim 1 wherein the pregelled modified starch is applied in a flume.

18. The method of claim 17 wherein the flume contains a suspension of salt and SAPP.

19. The method of claim 1 wherein the pregelled modified starch is applied by immersion of the potato strip in a dip characterized by a viscosity of greater that 1000 cp.

20. The method of claim 1 wherein the potato strips are partially dried before the coating step.

21. A french fry product produced according to the method of claim 1.

22. The french fry product of claim 21 wherein the coating comprises starch characterized by a Brookfield viscosity of from 18 to 40 cp when measured on a 6% solids basis.

23. The French fry product of claim 21 wherein the coating comprises starch characterized by a crosslinking level of from 350 to 650 ppm.

24. A method for producing a frozen potato product which comprises the steps of:
cutting the raw potatoes;
blanching the potatoes;
coating the potatoes with an aqueous suspension of a high amylose starch selected from the group consisting of high amylose rice starch and high amylose maize starch;
wherein the high amylose starch is applied in an aqueous suspension such that the solids pick up on the potato ranges from 0.3% to 3%;
parfrying the coated potatoes in hot oil; and
freezing the potatoes.

25. The method of claim 24 wherein the high amylose rice starch is characterized by an amylose content of 20% or greater and the high amylose maize starch is characterized by an amylose content of 40% or greater.

26. The method of claim 24 wherein the high amylose starch is applied in an aqueous suspension characterized by a degree of solids of from 1% to 5%.

27. The method of claim 24 wherein the starch is applied in an aqueous suspension such that the solids pick up on the potato ranges from 0.5% to 3%.

28. The method of claim 24 wherein the. high amylose starch is applied in a flume.

29. The method of claim 24 wherein the starch is applied by immersion of the potato strip in a dip characterized by a viscosity of greater than 1000 cp.

30. A french fry product produced according to the method of claim 24.
